(19) United States
(12) Patent Application Publication
(10) Pub. No.: US 2019/0203081 A1
(43) Pub. Date: Jul. 4, 2019

(54) FLUORINATED PRESSURE SENSITIVE ADHESIVE

(71) Applicant: 3M INNOVATIVE PROPERTIES COMPANY, St. Paul, MN (US)

(72) Inventors: Francois C. D'Haese, Antwerp (BE); Tatsuo Fukushi, Woodbury, MN (US); Katherine A. Gibney, St. Paul, MN (US); Klaus Hintzer, Kastl (DE); Tom Opstal, Laarne (BE); Jayshree Seth, Woodbury, MN (US); David J. Yarusso, Shoreview, MN (US); Yu Yang, Eden Prairie, MN (US)

(21) Appl. No.: 16/322,499

(22) PCT Filed: Aug. 8, 2017
(86) PCT No.: PCT/US2017/045914

§ 371 Date: Feb. 1, 2019

Related U.S. Application Data
(60) Provisional application No. 62/372,830, filed on Aug. 10, 2016.

(51) Int. Cl. C09J 7/38; B32B 7/06; B32B 7/12

(52) U.S. Cl. CPC C09J 7/385; B32B 7/06; C09J 2427/00; C09J 2205/114; C09J 2433/00; B32B 7/12

(57) ABSTRACT

Described herein is a pressure sensitive adhesive is comprising: (a) a high molecular weight (meth)acrylate polymer wherein the high molecular weight (meth)acrylate polymer is derived from (i) a C4 to C24 (meth)acrylate ester monomer; and (ii) 0 to less than 10 wt % of a polar comonomer based on the weight of the high molecular weight (meth)acrylate polymer; and (b) 10 to 100 parts of a low molecular weight fluorinated polymer per 100 parts of the high molecular weight (meth)acrylate polymer, wherein the low molecular weight fluorinated polymer has a glass transition temperature (Tg) of less than 40° C. The low molecular weight fluorinated polymer is preferably derived from fluorinated (meth)acrylate, fluorinated (meth)acrylate comprising a sulfonylamide group, fluorinated vinyl monomers, fluorinated vinyl ethers, or fluorinated styrene.

### TECHNICAL FIELD

A fluorinated pressure sensitive adhesive is described along with articles comprising the aforementioned pressure sensitive adhesive.

### SUMMARY

There is a desire to identify alternative pressure sensitive adhesives (PSA). In one embodiment, there is a desire to identify pressure sensitive adhesives that have sufficient adherence to low surface energy substrates such a polyalkylenes, and fluorine-containing surfaces. In one embodiment, there is a desire to identify pressure sensitive adhesives that have improved chemical resistance. In one embodiment, there is a desire to identify pressure sensitive adhesives that have good oil resistance.

In one aspect, a pressure sensitive adhesive is described comprising:
(a) a high molecular weight (meth)acrylate polymer wherein the high molecular weight (meth)acrylate polymer is derived from
   (i) a C4 to C24 (meth)acrylate ester monomer; and
   (ii) 0 to less than 10 wt % of a polar co-monomer based on the weight of the (meth)acrylate polymer; and
(b) 10 to 100 parts of a low molecular weight fluorinated polymer per 100 parts of the high molecular weight (meth)acrylate polymer, wherein the low molecular weight fluorinated polymer has a Tg of less than 40° C.

In another aspect, a multilayered article is described comprising a pressure sensitive adhesive composition, wherein the pressure sensitive adhesive composition comprises (a) a high molecular weight (meth)acrylate polymer wherein the high molecular weight (meth)acrylate polymer is derived from
(i) a C4 to C24 (meth)acrylate ester monomer; and
(ii) 0 to less than 10 wt % of a polar co-monomer based on the weight of the (meth)acrylate polymer; and

(b) 10 to 100 parts of a low molecular weight fluorinated polymer per 100 parts of the high molecular weight (meth)acrylate polymer, wherein the low molecular weight fluorinated polymer has a Tg of less than 40° C.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“backbone” refers to the main continuous chain of the polymer;

“copolymer” refers to a polymer derived from two or more different monomers and includes terpolymers, quadpolymers, etc.;

“crosslinking” refers to connecting two pre-formed polymer chains using chemical bonds or chemical groups in order to increase the modulus of the material;

“interpolymerized” refers to monomers that are polymerized together to form the backbone of a polymer;

“(meth)acrylate” refers to compounds containing either an acrylate (CH₂=CHCOOR) or a methacrylate (CH₂—CCH₃COOR) structure or combinations thereof;

“monomer” is a molecule which can undergo polymerization which then form part of the essential structure of a polymer;

“perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, nitrogen atoms, sulfur atoms, chlorine atoms, bromine atoms and iodine atoms.

The term “polymer” are used herein refers to a molecule comprising a chain having at least four interpolymerized monomeric units.

The term “alkyl” refers to a monovalent group that is a radical of an alkane, which is a saturated hydrocarbon. The alkyl can be linear, branched, cyclic, or combinations thereof and typically has 1 to 50 carbon atoms. In some embodiments, the alkyl group contains at least 1, 2, 3, 4, 5, 6, 8, or 10 carbon atoms; at most 50, 40, 30, 28, 26, 25, 20, or 15 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof The alkylene often has 1 to 50 carbon atoms. In some embodiments, the alkylene group contains at least 1, 2, 3, 4, 5, 6, 8, 10, 15, 20, or 25 carbon atoms; at most 50, 40, 30, 28, 26, 25, 20, 15, 10, 8, 6, 5, 4, or 3 carbon atoms. The radical centers of the alkylene can be on the same carbon atom (i.e., an alkylidene) or on different carbon atoms.

The term “arylene” refers to a divalent group that is a radical of an arene, that has typically, 4, 5, or 6 carbon atoms.

The term “aryl alkylene” refers to a divalent group that comprises both an aromatic group and an alkane group.

The term “aryl” refers to a monovalent group that is aromatic and carbocyclic or heterocyclic. The aryl can have one to five rings that are connected to or fused to the aromatic ring. The other ring structures can be aromatic, non-aromatic, or combinations thereof and typically has 3 to 30 carbon atoms. In some embodiments, the aryl group contains at least 3, 4, 5, 6, or 8 carbon atoms; at most 30, 28, 26, 25, 20, 15, or 10 carbon atoms. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “alkylaryl” refers to a monovalent group that is a combination of an alkyl and an aryl group. The alkylaryl can be an aralkyl, that is, an alkyl substituted with an aryl, or alkaryl, that is, an aryl substituted with an alkyl. The alkylaryl can have one to five rings that are connected to or fused to the aromatic ring and can comprise linear, branched, or cyclic segments, or combinations thereof The alkylaryl group typically has 4 to 30 carbon atoms. In some embodiments, the alkylaryl group contains at least 4, 5, 6, 8, 10, 15, 20, or 25 carbon atoms; at most 50, 40, 30, 28, 26, 25, 20, 15, or 10 carbon atoms.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

Pressure sensitive adhesives are a type of polymeric composition useful to adhere together two adherends. Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength. Materials that have been found to function well as pressure sensitive adhesives are polymers designed and formulated to exhibit the requisite viscoelastic properties resulting in a desired balance of tack, peel adhesion, and shear holding power.

Conventional pressure sensitive adhesives (PSAs) such as, for example, non-fluorinated acrylate-based adhesives are typically designed for adhesion to either substrates having high surface energy, such as, for example, stainless steel or to substrates having low surface energy, such as, for example, polyolefins. These conventional pressure sensitive adhesives do not adhere well to fluorinated substrates. Fluorinated surfaces are popular due to their inert nature which can, for example, (i) prevent food from sticking to a cooking pan, (ii) prevent stains from adhering to cloth or a digital display surface, or (iii) provide water and oil repellency to porous surfaces.

There is a continuous need for pressure sensitive adhesives that are applicable to a broad range of substrates, including substrates having high and low surface energy. In particular, it is desirable to provide pressure sensitive adhesives that adhere well to fluorine-containing surfaces. In addition or alternatively, in many applications, it is desirable that the pressure sensitive adhesives retain their adhesive properties under harsh conditions (such as chemical resistance, oil resistance, etc.).

The present disclosure is directed toward a fluorinated pressure sensitive adhesive comprising a high molecular weight (meth)acrylate polymer and a low molecular weight fluorinated polymer.

### Low Molecular Weight Fluorinated Polymer

The low molecular weight fluorinated polymer of the present disclosure is used to increase the tack (or stickiness) of the pressure sensitive adhesive.

The low molecular weight fluorinated polymer of the present disclosure has a Tg greater than about −20, −10, 0, or even 10° C. and less than 40° C., 35° C. or even 30° C. Unless otherwise mentioned, the Tg values of the materials disclosed herein are measured by DSC (differential scanning calorimetry) following methods known in the art, for example, ASTM D7426: Standard Test Method for Assignment of the DSC Procedure for Determining Tg of a Polymer or an Elastomeric Compound (D7426-08, reapproved 2013).

The low molecular weight fluorinated polymer of the present disclosure is derived from the polymerization of an ethylenically unsaturated fluorinated monomer. The fluorinated monomer may be partially fluorinated (comprising at least one C—H bond and at least one C-F bond) or perfluorinated (comprising no C—H bonds and at least one C—F bond).

In one embodiment, the backbone of the low molecular weight fluorinated polymer comprises at least 4, or even 5 interpolymerized monomeric units and at most 25, 30, 40, or even 50 interpolymerized monomeric units.

In one embodiment, the low molecular weight fluorinated polymer has a number average molecular weight (Mn) of at least 0.5, 1, or even 2 kilograms/mole and at most 5, 8, or even 10 kilograms/mole. The number average molecular weight may be determined by using gel permeation chromatography, as is known in the art.

The low molecular weight fluorinated polymer disclosed herein is fluorinated, meaning it contains C—F bonds. In one embodiment, at least 10%, 20%, 30%, 40%, 50%, 60%, or even 70% of all of the C—H and C—F bonds in the low molecular weight fluorinated polymer are C—F bonds. The fluorinated low molecular weight fluorinated polymer may be partially fluorinated (i.e., wherein the backbone and/or pendent groups of the polymer comprise at least one C—F bond and at least one C—H bond) or highly fluorinated, wherein the backbone and pendent groups of the polymer comprise C—F bonds and no C—H bonds, however the terminal groups, where the polymerization reaction initiates or terminates may comprise C—H bonds as a result of the initiator and/or chain transfer agent used in the polymerization reaction.

In one embodiment, the low molecular weight fluorinated polymer is derived from an ethylenically unsaturated fluorinated monomer. The fluorinated monomer may be partially fluorinated (comprising at least one C—H bond and at least one C—F bond) or perfluorinated (comprising no C—H bonds and at least one C—F bond). Exemplary ethylenically unsaturated monomers include: a (meth)acrylate monomer, a vinyl monomer, vinyl ether monomer, a styrene monomer, and combinations thereof

In one embodiment, the low molecular weight fluorinated polymer of the present disclosure is derived from a fluorinated (meth)acrylate monomer optionally in combination with a hydrocarbon (meth)acrylate (i.e., not comprising C—F bonds).

In one embodiment, the acrylate monomer comprises a fluoroalkyl group, wherein the fluoroalkyl group comprises from 1 to 10 carbon atoms, 3 to 10 carbon atoms, or even 3 to 8 carbon atoms of the general formula (I):

CH₂=C(R¹)—COO—(CH₂)ₘ—(CF₂) ₙ—Z (I)

where R¹ is a hydrogen atom or a methyl group; Z is a hydrogen atom or a fluorine atom; n is an integer of 1, 2, 3, 4, 5, 6, 7, 8, 9, or 10; and m is an integer of 0, 1, 2, 3, or 4.

Exemplary fluorinated acrylate monomers include: trifluoromethyl (meth) acrylate, pentafluoroethyl (meth) acrylate, heptafluoro propyl (meth) acrylate, nonafluoro butyl (meth) acrylate, undecafluoropentyl (meth) acrylate, tridecafluorohexyl (meth) acrylate, pentadecafluoroheptyl (meth) acrylate, and (meth)acryloyl monomers.

Since there is a tendency for glass transition temperature to become high, also among these, the methacrylate type is more preferable than an acrylate type.

In one embodiment, a fluorinated (meth)acrylate monomer is of formula (II):

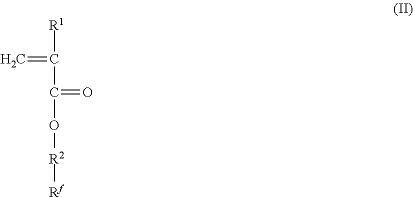

wherein R¹ is H or CH₃; R² is a linking group; R^{f} is a fluorinated alkyl group, optionally comprising a catenated heteroatom such as O, N, or S.

R² in Formula II is a linking group, linking the ester from the (meth)acryl group with the fluorinated alkyl group. In one embodiment, R² comprises at least one of an alkylene, a carbamate group, an ether group, an ester group, a urea group, and combinations thereof The carbamate, ether, ester, and urea group may further comprise an alkylene, arylene, or aryl alkylene. Exemplary R² groups include: —CH₂—; —C₂H₄—; —C₃H₆—; —C₄H₈—; —C2H4O—C(=O)NH-(C₆H₄)—CH₂—(C₆H₄)CH₂CO₂C₂H₄—; —C₂H₄O—C(=O )NH—(C₆H₃CH₃)—NHCO₂C₂H₄—; —C₂H₄NHCO₂C₂H₄—; —(C₂H₄)ᵥ— wherein v is 1-5; and —C₂H₄NHC(=O)—.

In one embodiment, R^{f} of Formula II is a C1-C10 fluorinated alkyl group, optionally comprising at least one catenated heteroatom such as O, N, or S. In one embodiment, R^{f} is perfluorinated.

In one embodiment, the low molecular weight fluorinated polymer comprises pendent sulfonylamide groups (i.e., —S(=O)₂—N(R)—), which extend from the backbone. In one embodiment, the low molecular weight fluoropolymer comprises a plurality of pendent sulfonylamide groups, in other words comprises at least 2, 3, 5 and at most 25, 30, 40 or even 50 pendent sulfonylamide groups per polymer. In one embodiment, the low molecular weight fluorinated (meth)acrylate polymer of the present disclosure is derived from at least 50, 60, 70, 80, 85 or even 90 mole % or even 100 mole % of a monomeric unit comprising a pendent sulfonylamide group.

An exemplary fluorinated (meth)acrylate monomer comprising a sulfonylamide group is of the formula III:

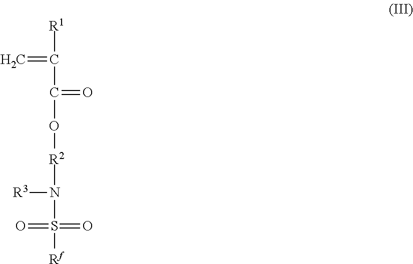

wherein R¹ is H or CH₃, preferably R¹ is CH₃; R² is a linking group; R³ is H or an alkyl group; and R_{f} comprises a fluorinated group.

R² in Formula III is a linking group, linking the ester from the (meth)acryl group with the sulfonylamide moiety. In one embodiment, R² comprises at least one of an alkylene, a carbamate group, an ether group, an ester group, a urea group, and combinations thereof The carbamate, ether, ester, and urea group may further comprise an alkylene, arylene, or aryl alkylene. Exemplary R² groups include: —CH₂—; —C₂H₄—; —C₃H₆—; —C₄-H₈—; —C2H₄OC(=O)NH—(C₆H₄)—CH₂—(C₆H₄)CH₂CO₂C₂H₄—; —C₂H₄O—C(=O)NH—(C₆H₃CH₃)—NHCO₂C₂H₄—; —C₂H₄NHCO₂C₂H₄—; —(C₂H₄)ᵥ— wherein v is 1-5; and —C₂H₄NHC(=O)—.

R_{f} is a fluorinated alkyl or fluorinated aryl group, comprising 1 to 10 carbon atoms. Rf may be partially fluorinated or perfluorinated (i.e., fully fluorinated). Exemplary R_{f} groups include: —CF₃; —C₂F₅; —C₃F₇; —C₄F₉; —C₅F₁₁; —C₆F₁₃; —C₈F₁₇; C₉F₁₉; and —C₆F₅.

Exemplary fluorinated (meth)acrylate monomers according to formula III include:

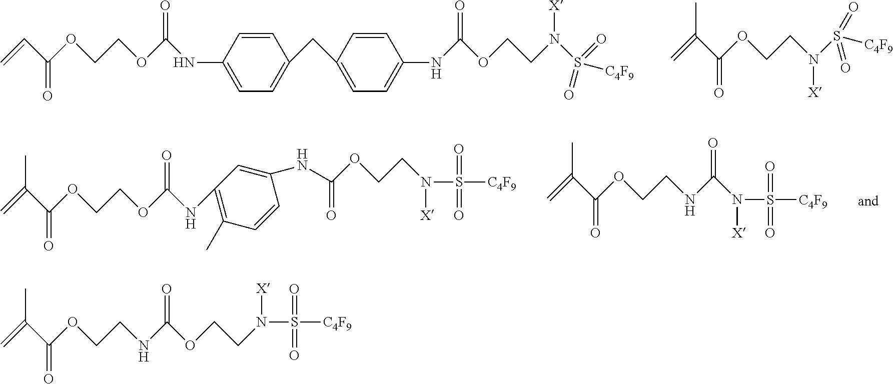

wherein X′ is CH₃ or H.

In one embodiment, the low molecular weight fluorinated polymer is derived from fluorinated vinyl monomers such as fluorinated olefins, and fluorinated vinyl ethers.

In one embodiment, the fluorinated olefins include those of the formula CX¹X²=CX³Y, where X¹, and X² are independently selected from H or F; X³ is selected from H, F, an alkyl group, or a fluorinated alkyl group; and Y is selected from H, F, or an alkyl group, optionally comprising a functional group, such as an ether. In one embodiment, the fluorinated vinyl monomers are fluorinated vinyl ethers. Exemplary fluorinated vinyl monomers include: tetrafluoroethylene (TFE), vinylidene fluoride (VDF), vinyl fluoride (VF), hexafluoropropylene (HFP), pentafluoropropylene, trifluoroethylene, trifluorochloroethylene (CTFE), CF₃CF=CH₂, perfluoro ether monomer, and combinations thereof

In one embodiment, the low molecular weight fluorinated polymer is a copolymer derived from at least vinylidene fluoride, hexafluoropropylene, and tetrafluoroethylene.

In one embodiment, the low molecular weight fluorinated polymer is a copolymer derived from a perfluorinated vinyl ether and additional monomers, preferably hydrocarbon monomers. These additional monomers may be incorporated into the low molecular weight fluorinated polymer to modify its properties.

In one embodiment, the fluorinated vinyl ethers include those of the formula (IV):

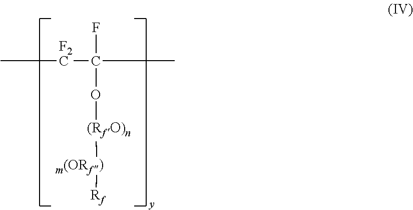

wherein R_{f″} and R_{f′} are independently linear or branched fluoroalkylene radical groups comprising 2, 3, 4, 5, or 6 carbon atoms; m and n are independently an integer selected from 0, 1, 2, 3, 4, 5, 6, 7, 8, 9, and 10; R_{f} is a fluoroalkyl group comprising 1, 2, 3, 4, 5, or 6 carbon atoms; and y is at least 1 or at least 2 comparted to the total amount of monomeric units present in the low molecular weight fluorinated polymer.

Exemplary additional monomers include vinylesters, including vinyl acetate and vinyl benzoate, or vinylethers, including hydroxyl containing vinyl ether and hydroxyl containing vinyl ether; CH₂=CH—(CH₂)ₒ—O—(CH₂)_{c}—OH, where o is 0 or 1 and c is 1 to 10; CH₂=CH—(CH₂)ₒ—O—(CH₂)_{c}—CN, where o is 0 or 1 and c is 1 to 10; CH₂=CH—C₆H₅; and CH₂=CH—C₆H₄OH. Exemplary monomers used include CF₂=CF—O—R_{F}, CF₂=[—O—-CF(CF₃)—CF₂]_{z}—O—RF; CF₂=CF—[O—(CF₂)ₐ—]_{b}O—R_{F}, where R_{F} is CF₃, C₂F₅, or C₃F₇, z is an integer from 1- 3, a is an integer from 1-6, and b is an integer from 1-4; CH₂=CH—OC(=O)R where R is CH₃, C₂H_{5,} C₃H₇ or C(CH₃)R¹R² where R¹ and R² independently represent an alkyl group having at least one carbon atom; CH₂=CH—CH₂—OC(=O)R where R is CH₃, C₂H₅, or C₃H₇ or C(CH₃)R¹R² where R¹ and R² independently represent an alkyl group having at least one carbon atom.

Exemplary low molecular weight fluorinated polymers include those having the following repeat unit sequence:

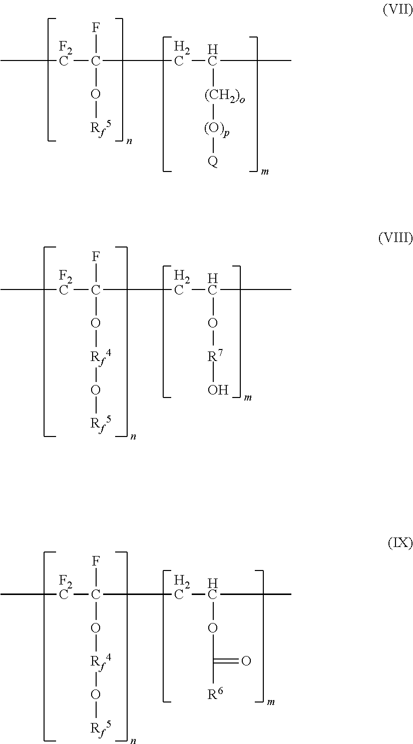

where R_{f}¹ and R_{f}² are independently selected from a linear or branched fluorinated alkylene group comprising from 1 to 6 carbon atoms; R_{f}⁴ is a perfluorinated linear or branched alkylene group comprising from 1 to 6 carbon atoms; R_{f}⁵ is a perfluorinated alkyl group comprising 1 to 12 carbon atoms, which may optionally comprise at least one catentated oxygen atom; R⁶ is a non-fluorinated alkyl, aryl, or alkylaryl comprising 1 to 12 carbon atoms; R⁷ is a alkylene, arylene or alkylarylene group that may be substituted and comprising from 1 to 18 carbon atoms; Q is selected from —C(=O)R wherein R is a linear, cyclic, or branched alkyl group comprising 1 to 10 carbon atoms optionally comprising at least one of a nitrile moiety or a hydroxide moiety, an aryl group comprising 3 to 10 carbon atoms optionally comprising at least one of a nitrile moiety or a hydroxide moiety, or an alkylaryl group comprising 4 to 10 carbon atoms optionally comprising at least one of a nitrile moiety or a hydroxide moiety; o is 0, 1, or 2; p is 0 or 1; n is an integer of at least 2; and m is an integer of at least 2. Exemplary R groups include benzene and phenol.

It is noted that the n and m integers represent the number of times the polymerized unit is repeated in the polymer structure. Although written sequentially, the monomeric units may be block polymerized or randomly polymerized together, wherein the integers n and m represent the number of times the monomeric unit appears in the polymer.

It is preferred that the mole ratio of the fluorinated vinylether and the vinylacetate is in the range of from 10:1 to 1:10, preferably in the range of 1:1 to 1:2.

The low molecular weight fluorinated polymer can be prepared by free radical initiated polymerization in solvent (e.g. tert-butanol, ethylacetate) or in aqueous suspension or emulsion.

In one embodiment, the low molecular weight fluorinated polymer is derived from styrene monomers.

In one embodiment, the low molecular weight fluorinated polymer is derived from styrene monomers such as those represented by formula (VIII)

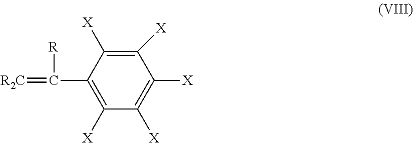

wherein each R is independently selected from H or F and each X is independently selected from H or F, wherein at least one X is F. Preferably all X are F.

In one embodiment, the low molecular weight fluorinated polymer is derived from styrene monomers such as

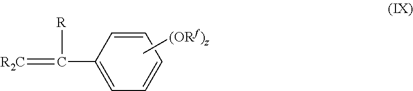

wherein each R is independently selected from H or F and R^{f} is a fluorinated alkyl group comprising from 1 to 10 carbon atoms, and z is an integer from 1-3. The subscript z, denotes to how many (—R^{f}) groups are located off the ring, with the proviso that the fluorine content is higher than 10%. Such styrenic monomers are disclosed in EP 355025 A2 (Fuss et al.).

In one embodiment, in addition to the interpolymerized fluorinated (meth)acrylate monomer, the low molecular weight fluorinated (meth)acrylate polymer may comprise additional monomeric units randomly polymerized into the low molecular weight polymer. These additional monomeric units may be incorporated into the low molecular weight fluorinated (meth)acrylate polymer to modify its properties.

Exemplary monomers interpolymerized with the fluorinated (meth)acrylate monomers include: hydrocarbon (meth)acrylates such as polyalkyleneoxy (meth)acrylate, cyclohexyl (meth)acrylate, methyl methacrylate, and isobornyl (meth)acrylate; (meth)acryloyl-containing monomers such as acryloyl benzophenone and para-acryloxyethoxybenzophenone; hydroxyl-containing monomers such as a reaction product of acrylic acid and a glycidyl ester of versatic acid commercially available under the trade designation “ACE HYDROXYLACRYLATE MONOMER” from Hexion Specialty Chemicals, Belgium, 4-hydroxybutyl acrylate commercially available from BASF AG, Germany and 2-hydroxy-3-phenoxypropyl acrylate from Shin Nakamura, Japan; carboxyl-containing monomers such as (meth)acrylic acid, itaconic acid, fumaric acid, crotonic acid, citraconic acid, and maleic acid, β-carboxyethylacrylate; and nitrogen-containing monomers such as amine functional and amide functional monomers, such as N,N-dialkylaminoalkyl (meth)acrylates, N,N-dialkyl(meth)acrylamide, N-vinyl-2-pyrrolidone, N-vinyl caprolactam, and acrylonitrile; vinyl esters such as vinyl acetate, and those commercially available under the trade designations “VEOVA-EH”, “VEOVA 9” and “VEOVA 10” from Momentive Specialty Chemicals Inc., Columbus, Ohio; and combinations thereof

To function as a tackifier, the low molecular weight fluorinated polymer used in the present disclosure should decrease the plateau shear modulus of the composition relative to the high molecular weight (meth)acrylate polymer and modify the glass transition temperature (Tg) of the composition relative to that of the high molecular weight (meth)acrylate polymer. In one embodiment, the low molecular weight fluorinated polymer of the present disclosure should have a glass transition temperature of at least −20, −15, −10, −5, or even −1° C.; and less than 40, 35, or even 30° C.

The low molecular weight fluorinated polymer of the present disclosure can be prepared, for example, by free radical initiated polymerization of the fluorinated (meth) acrylate, vinyl, and/or a styrene monomers along with any optional comonomers.

Such free radical polymerizations are known in the art. By adjusting the concentration of the monomers, the concentration and activity of the initiator, the temperature, and the chain-transfer agent used, if any, the molecular weight of the low molecular weight fluorinated polymer can be controlled to form the polymer. Such low molecular weight fluorinated polymer and methods of making are disclosed in U.S. Pat. No. 7,047,379 (Jariwala et al.), and U.S. Pat. Publ. No. 2016-0144312, herein incorporated by reference.

The low molecular weight fluorinated polymers of the present disclosure are combined with at least a high molecular weight (meth)acrylate polymer to provide the pressure sensitive adhesive composition. In one embodiment, the pressure sensitive adhesive comprises 10 to 100 parts of the low molecular weight fluorinated polymer to 100 parts of the high molecular weight (meth)acrylate polymer.

### (Meth)acrylate Polymer

The high molecular weight (meth)acrylate polymer contains a polymerized form of at least one linear or branched alkyl (meth)acrylate monomer, wherein the linear or branched alkyl group of the alkyl (meth)acrylate monomer preferably comprises from 4 to 24, more preferably from 4 to 20, even more preferably 6 to 18, still more preferably from 8 to 12 carbon atoms. As used herein, the “high molecular weight (meth)acrylate polymer” will be referred to as an “acrylate polymer”, unless otherwise noted. The acrylate polymer can be prepared by polymerizing a mixture of the above-mentioned monomers by any suitable method known in the art.

In a preferred aspect, at least one linear or branched alkyl (meth)acrylate monomer is selected from the group consisting of butyl acrylate, such as n-butyl acrylate and isobutyl acrylate; pentyl acrylate, such as n-pentyl and iso-pentyl acrylate; hexyl acrylate, such as n-hexyl acrylate and iso-hexyl acrylate; octyl acrylate, such as iso-octyl acrylate, 2-octyl acrylate, and 2-ethylhexyl acrylate; nonyl acrylate; decyl acrylate, such as 2-propylheptyl acrylate; dodecyl acrylate; lauryl acrylate; octadecyl acrylate, such as C18 acrylate derived from Guerbet alcohols, which can be 2-heptyl undecanyl acrylate; and any combinations or mixtures thereof

Typically, the high molecular weight (meth)acrylate polymer is prepared from a monomer mixture comprising from 50 to 100 parts, from 70 to 100 parts, from 80 to 100 parts, or even from 90 to 100 parts by weight of at least one linear or branched alkyl (meth)acrylate monomer, wherein the linear or branched alkyl group of the alkyl (meth)acrylate monomer preferably comprises from 1 to 24, more preferably from 4 to 20, even more preferably 4 to 18, still more preferably from 4 to 12 carbon atoms.

In one embodiment, the high molecular weight (meth)acrylate polymer comprises less than 10, 5, 3, 1, 0.5 wt % of a polar co-monomer based on the weight of the high molecular weight (meth)acrylate. The polar co-monomer may be fluorinated or nonfluorinated.

In one embodiment, the high molecular weight (meth)acrylate polymer comprises substantially no polar non-fluorinated co-monomer (i.e., less than 0.05, 0.01, 0.001 wt % or even none).

The polar monomers preferably have one or more hydrophilic groups such as hydroxy, thiol, amino, amid, ionic groups such as an acid, e.g. carboxylic acid, sulphonic acid, phosphoric acid, phosphoric acid and salts thereof, an ammonium group etc . . . , or one or more polar groups such as a nitrile. Examples of polar monomers are methacrylic acid, acrylic acid, itaconic acid, hydmxyalkyl (meth)acrylates, β-carboxy ethyl (meth)acrylate, styrene sulfonic acid or the sodium salt thereof, maleic acid, fumaric acid, (meth)acrylamidcs and substituted (meth)acrylamides, N-vinylpyrrolidone, N-vinyl caprolactam, acrylonitrile, dimethyl amino propyl methacrylate, Preferred polar monomers include acrylic acid, methacrylic acid,(meth)acrylamide and substituted (meth)acrylamide. Particular suitable examples of polar monomers include at least one of (meth)acrylic acid, itaconic acid, fumaric acid, crotonic acid, citraconic acid, and maleic acid, 0-carboxyethylacrylate; N,N-dialkylaminoalkyl (meth)acrylates; acryloylmorpholine; and combinations thereof

In one embodiment, one or more of acrylic acid, methacrylic acid or any other monomers bearing an acid moiety can be included in the acrylate polymer as well, however, typically at amounts no more than 10%, 8%, 6%, 5%, 4%, 3%, 2%, 1.5%, 1%, or even 0.5% by weight based on the total weight of the acrylate polymer. In one embodiment, the acrylate polymer is free of monomers bearing an acid moiety.

In one embodiment, one or more of unsaturated co-monomers bearing a basic moiety can be included in the acrylate polymer as well, however, typically at amounts no more than 10%, 8%, 6%, 5%, 4%, 3%, 2%, 1.5%, 1%, or even 0.5% by weight based on the total weight of the acrylate polymer. In one embodiment, the acrylate polymer is free of monomers bearing a basic moiety. Exemplary monomers bearing a basic moiety include for example N,N-dialkyl(meth)acrylamide, N,N-dialkylaminoalkyl (meth)acrylates, N-vinyl-2-pyrrolidone, N-vinyl caprolactam, (meth)acrylonitrile, (meth)acrylamide, and combinations thereof

Typically, the amount of polar co-monomers containing an acidic or basic moiety used in the acrylate polymer should be kept low to avoid incompatibility of the acrylate polymer with the low molecular weight fluorinated (meth)acrylate polymer.

To function as a tackifier, the low molecular weight fluorinated polymer needs to be at least partially soluble in the high molecular weight (meth) acrylate polymer. Preferably the tackifier is completely soluble in the high molecular weight (meth) acrylate polymer. To be an effective tackifier, the low molecular weight fluorinated polymer reduces the plateau modulus and raises the Tg of the mixture relative to the Tg of high molecular weight (meth) acrylate polymer.

In one embodiment, one or more other monoethylenically unsaturated co-monomers may be present in the monomer mixture used to prepare the acrylate polymer, in an amount of from 0.5 to 50 parts co-monomer, and are thus typically polymerized with the acrylate monomers. Examples of suitable co-monomers include include alkyl(meth)acrylate monomers comprising from C1 to C3 alkyl groups. Examples include methyl acrylate; ethyl acrylate; propyl acrylate, such as n-propyl acrylate and isopropyl acrylate. Other optional comonomers include cyclohexyl (meth)acrylate, vinyl acetate, isobornyl (meth)acrylate, hydroxyalkyl (meth)acrylates, vinyl esters of neodecanoic, neononanoic, neopentanoic, 2-ethylhexanoic, or propionic acids (e.g., available from Union Carbide Corp., Danbury, Conn. under the trade designation “VYNATES”), vinylidene chloride, alkyl vinyl ethers, ethoxyethoxy ethyl acrylate and methoxypolyethylene glycol 400 acrylate (available from Shin Nakamura Chemical Co., Ltd. under the trade designation “NK ESTER AM-90G”), and any combinations or mixtures thereof When present, the other monoethylenically unsaturated co-monomer is typically used in amounts ranging from 0.5 to 25, from 1.0 to 15, from 1.0 to 8.0, from 2.0 to 6.0, or even from 3.0 to 5.0 parts, by weight per 100 parts by weight of acrylate polymer.

In one embodiment, a fluorinated (meth)acrylate monomer is polymerized into the high molecular weight (meth)acrylate polymer to increase the compatibility of the low molecular weight fluorinated polymer with the high molecular weight (meth)acrylate polymer. Such amounts of the fluorinated (meth)acrylate monomer may include up to 10, 20, or even 30 wt% based on the weight of the high molecular weight polymer. The fluorinated (meth)acrylate monomer is preferably an fluorinated acrylate monomer. Exemplary fluorinated co-monomers include 2,2,2,-trifluoroethyl (meth)acrylate, 4,4,4,3,3,2,2 heptafluoro(meth)acrylate, N-methyl perfluorobutylsulphonamidoethylacrylate, CF₃(CF₂)₃(CH₂)₂OCOCH=CH₂, and CF₃(CF₂)₅(CH₂)₂OCOCH₂.

Generally, the monomer mixture used to prepare the acrylate polymer, includes an appropriate initiator. For polymerization by ultraviolet light, a photoinitiator is included. Useful photoinitiators include substituted acetophenones such as benzyl dimethyl ketal and 1-hydroxycyclohexyl phenyl ketone, substituted alpha-ketols such as 2-methyl-2-hydroxypropiophenone, benzoin ethers such as benzoin methyl ether, benzoin isopropyl ether, substituted benzoin ethers such as anisoin methyl ether, aromatic sulfonyl chlorides, photoactive oximes and azo-type initiators. The photoinitiator may be used in an amount from about 0.001 to about 5.0 parts by weight, preferably from about 0.01 to about 3.0 parts by weight, more preferably in an amount from 0.05 to 0.5 parts by weight, and more preferably in an amount from 0.05 to 0.3 parts by weight per 100 parts by weight of total monomer.

The monomer mixture used to prepare the acrylate polymer, may also be polymerized by thermal polymerization or by a combination of thermal and radiation polymerization. For thermal polymerization, a thermal initiator is included. Thermal initiators useful in the present invention include, but are not limited to azo, peroxide, persulfate, and redox initiators. Azo-type initiators, such as e.g. the “Vazo” line, commercially available from The Chemours Co., are particularly preferred. The thermal initiator may be used in an amount from about 0.01 to about 5.0 parts by weight per 100 parts by weight of total monomer, preferably from 0.025 to 2 weight percent.

In one embodiment, the acrylate polymer has a number average molecular weight (Mn) of at least 20; 25; 40; 50; 100; 300; 500; 750; 1000; or even 1500 kilograms/mole.

In one embodiment, the acrylate polymer has a Tg of at least −70, −60, or even −50° C.; and at most 0, −10, −20, or even −30° C.

In one embodiment of the present disclosure, the acrylate polymer may or may not be crosslinked. The crosslinking agent used to crosslink the polymer would depend on the cure-sites present in the acrylate polymer. Useful crosslinking agents include: multifunctional (meth)acrylates, multifunctional aziridines, polycarbodiimides, triazines, and combinations thereof. Exemplary crosslinking agents include substituted triazines such as 2,4,-bis(trichloromethyl)-6-(4-methoxy phenyl)-s-triazine, 2,4-bis(trichloromethyl)-6-(3,4-dimethoxyphenyl)-s- triazine, and the chromophore-substituted halo-s-triazines disclosed in U.S. Pat. Nos. 4,329,384 and 4,330,590 (Vesley). Examples of useful multifunctional (meth)acrylates included alkyl (meth)acrylates such as trimetholpropane triacrylate, pentaerythritol tetra-acrylate, 1,2 ethylene glycol diacrylate, 1,4 butanediol diacrylate, 1,6 hexanediol diacrylate, and 1,12 dodecanol diacrylate.

In one embodiment, the crosslinking agent comprises a polymeric UV crosslinkable polymer as disclosed in U.S. Pat. Publ. No. 2015291853 (D'Haese) herein incorporated by reference.

### Additional Components

In addition to the low molecular weight fluorinated polymer and the high molecular weight (meth)acrylate polymer, the pressure sensitive adhesive composition may comprise additional components to impact the performance and/or properties of the PSA composition. Such additives include plasticizers, additional tackifiers, crosslinking agents, UV stabilizers, antistatic agents, colorants, antioxidants, fungicides, bactericides, organic and/or inorganic filler particles, and the like.

Plasticizers can be used to adjust the glass transition temperature and/or to adjust the modulus of the pressure sensitive adhesive composition to improve the adhesion of the composition to a substrate.

Exemplary plasticizers include: hydrocarbon oils (e.g., those that are aromatic, paraffinic, or naphthnenic), hydrocarbon resins, polyterpenes, rosin esters, phthalates (e.g., terephthalate), phosphates esters, phosphates (e.g., tris(2-butoxyethyl) phosphate), dibasic acid esters, fatty acid esters, polyethers (e.g., alkyl phenyl ether), epoxy resins, sebacate, adipate, citrate, trimellitate, dibenzoate, or combinations thereof

In one embodiment, the plasticizer is a fluorinated compound. Such fluorinated plasticizers may include: an ultralow viscosity and/or liquid fluoroelastomer available under the trade designation “3M DYNEON FC 2210X” available from 3M Co., St. Paul, Minn.; “DAI-EL G101” available from Daikin Industries, Ltd., Osaka, Japan; and “VITON LM” which used to be commercially available from The Chemours Co., Wilmington, Del.. Additional fluorinated plasticizes include fluorinated oils such as those available under the trade designation “KRYTOX” commercially available from The Chemours Company, Wilmington, Del.; “DEMNUM” commercially available from Daikin Industries Ltd., Osaka, Japan; and “FOMBLIN” commercially available from Solvay S. A. Brussels, Belgium.

The plasticizers may be present in the composition in any suitable amount, such as for example, amounts up to about 50, 70, or even 100 parts by weight, based on 100 parts by weight of the high molecular weight (meth)acrylate polymer.

In additional to the low molecular weight fluorinated polymer described herein for use as a tackifier in a pressure sensitive adhesive composition, additional non-fluorinated tackifiers may be used.

Exemplary non-fluorinated tackifiers include: rosins and their derivatives (e.g., rosin esters); polyterpenes and aromatic-modified polyterpene resins; coumarone-indene resins; hydrocarbon resins, for example, alpha pinene-based resins, beta pinene-based resins, limonene-based resins, aliphatic hydrocarbon-based resins, aromatic-modified hydrocarbon-based resins; or combinations thereof. Non-hydrogenated tackifiers resins are typically more colorful and less durable (i.e., weatherable). Hydrogenated (either partially or completely) tackifiers may also be used. Examples of hydrogenated tackifiers include, for example: hydrogenated rosin esters, hydrogenated acids, hydrogenated aromatic hydrocarbon resins, hydrogenated aromatic-modified hydrocarbon-based resins, hydrogenated aliphatic hydrocarbon-based resins, or combinations thereof. Examples of additional synthetic tackifiers include: phenolic resins, terpene phenolic resins, poly-t-butyl styrene, acrylic resins, or combinations thereof. In one embodiment, the non-fluorinated tackifier may be present in the pressure sensitive composition in an amount of greater than about 10, 20, or even 40 parts by weight and no more than 100 parts by weight based on 100 parts by weight of the high molecular weight (meth)acrylate polymer.

Other optional additives include, for example, stabilizers (e.g., anti-oxidants or UV-stabilizers), pigments, dyes, or combinations thereof. Use of such additives is well known to those of ordinary skill in the art. The additives may be present in an amount from 0.5% by weight to 5% by weight based upon the weight of the total pressure sensitive adhesive. Certain additives may be of lower weight percent, e.g., a pigment may be added at less than 0.05% or even less than 0.005% by weight based on 100 parts of the high molecular weight (meth)acrylate polymer.

Preferred anti-oxidants include phenols, phosphites, thioesters, amines, polymeric hindered phenols, copolymers of 4-ethyl phenols, reaction product of dicyclopentadiene and butylene, or combinations thereof. Additional examples include phenyl-alpha-naphthylamine, phenyl-beta-naphthylamine, phenyl-beta-naphthylene, 2,2′-methylene bis (4-methyl-6-tertiary butyl phenol), phenolic-based anti-oxidants sold under the trade designation “CIBA IRGANOX 1010” by from Ciba Specialty Chemicals Corp., Tarrytown, N.Y., or combinations thereof

UV-stabilizers such as UV-absorbers are chemical compounds that can intervene in the physical and chemical processes of photoinduced degradation. Exemplary UV-absorbers include: benzotriazole compound, 5-trifluoromethyl-2-(2-hydroxy-3-alpha-cumyl-5-tert-octylphenyl)-2H-benzotriazole, or combinations thereof. Other exemplary benzotriazoles include: 2-(2-hydroxy-3,5-di-alpha-cumylphehyl)-2H-benzotriazole, 5-chloro-2-(2-hydroxy-3-tert-butyl-5-methylphenyl)-2H-benzotiazole, 5-chloro-2-(2-hydroxy-3,5-di-tert-butylphenyl)-2H-benzotriazole, 2-(2-hydroxy-3,5-di-tert-amylphenyl)-2H-benzotriazole, 2-(2-hydroxy-3-alpha-cumyl-5-tert-octylphenyl)-2H-benzotriazole, 2-(3-tert-butyl-2-hydroxy-5-methylphenyl)-5-chloro-2H-benzotriazole, or combinations thereof. Additional exemplary UV-absorbers include 2(-4,6-diphenyl-1-3,5-triazin-2-yl)-5-hexcyloxy-phenol, and those available from Ciba Specialty Chemicals Corp. sold under the trade designations “CIBA TINUVIN 1577” and “CIBA TINUVIN 900”. In addition, UV-absorber(s) can be used in combination with hindered amine light stabilizer(s) (HALS) and/or anti-oxidants. Exemplary HALSs include those available from Ciba Specialty Chemicals Corp. sold under the trade designations “CIBA CHIMASSORB 944” and “CIBA TINUVIN 123”.

### Pressure Sensitive Adhesive Composition

In one embodiment, the pressure sensitive adhesive composition would comprise at least 10, 25 or even 50 parts; and no more than 100 parts of the low molecular weight fluorinated polymer per 100 parts of the high molecular weight (meth)acrylate polymer.

The pressure sensitive adhesive composition comprising the low molecular weight fluorinated polymer and the high molecular weight (meth)acrylate polymer, along with optional additives may be formulated in a solvent or solventless process.

The pressure sensitive adhesive composition according to the invention may be obtained using techniques commonly known to those skilled in the art of formulating pressure sensitive adhesive formulations.

In one embodiment, the pressure sensitive adhesive composition is hot melt processable.

In one embodiment, the pressure sensitive adhesive composition is crosslinked.

The crosslinked pressure sensitive adhesives and the uncrosslinked or crosslinkable pressure sensitive adhesive compositions, in particular the hot melt and solution processable adhesives and precursors thereof, may advantageously be used to prepare a wide range of adhesive tapes and articles. Many of these tapes and articles contain backings or other substrates to support the layer of adhesive. Double-sided tapes are adhesive tapes that have adhesive on opposite sides of a backing layer. The adhesives on the two sides may be the same or different. The backing layer may be a film, a non-woven web, paper, or a foam. Other adhesive tapes and articles do not contain a backing or substrate layer and therefore are free standing adhesive layers. Transfer adhesive tapes are an example of such an adhesive article. Transfer adhesives tapes, also called transfer tapes, have an adhesive layer delivered on one or more release liners. The adhesive layer has no backing within it so once delivered to the target substrate and the liner is removed, there is only adhesive. Some transfer tapes are multi-layer transfer tapes with at least two adhesive layers that may be the same or different.

Transfer tapes are widely used in the printing and paper making industries for making flying splices, as well as being used for a variety of bonding, mounting, and matting applications both by industry and by consumers.

In one embodiment, the pressure sensitive adhesive compositions may be easily coated upon a carrier film by conventional coating techniques to produce adhesive coated sheet materials or coated and cured via ultraviolet or e-beam radiation. The coating thickness will vary depending upon various factors such as, for example, the particular application or the coating formulation. Coating thicknesses of 10, 20, 25, 30, 40, 50, 60, 75, 100, 125, 150, 200, 250 μm, or 300 μm are contemplated.

The carrier film may be a flexible or inflexible backing material, or a release liner. Exemplary materials useful as the carrier film for the adhesive articles of the disclosure include, but are not limited to, polyolefins such as polyethylene, polypropylene (including isotactic polypropylene and high impact polypropylene), polystyrene, polyester, including poly(ethylene terephthalate), polyvinyl chloride, poly(butylene terephthalate), poly(caprolactam), polyvinyl alcohol, polyurethane, poly(vinylidene fluoride), cellulose and cellulose derivatives, such as cellulose acetate and cellophane, and wovens and nonwovens. Commercially available carrier film include kraft paper (available from Monadnock Paper, Inc., Bennington, N.H.); spun-bond poly(ethylene) and poly(propylene), such as those available under the trade designations “TYVEK” and “TYPAR” (available from DuPont, Inc., Wilmington, Del.); and porous films obtained from poly(ethylene) and poly(propylene), such as those available under the trade designations “TESLIN” (available from PPG Industries, Inc., Pittsburgh, Pa.), and “CELLGUARD” (available from Hoechst-Celanese, Irving, Tex.). The carrier film delivers the pressure sensitive adhesive of the present disclosure to the desired substrate. The carrier film may be blank or may comprise on the surface opposite the pressure sensitive adhesive, a pigment, indicia, text, design, etc., which is then fixedly attached to the surface of the substrate.

In one embodiment, a layer of the pressure sensitive adhesive is fixedly attached to a backing layer. The backing layer may be any material conventionally utilized as a tape backing. In one embodiment, a chemical primer layer is disposed between the pressure sensitive adhesive and the backing layer to improve the adhesion of the pressure sensitive adhesive to the backing layer. Such primer layers are known in the art. In one embodiment, the backing material is corona treated, plasma treated, and/or nanostructured to improve the adhesion of the PSA to the backing material. Such nanostructure materials can be made as described, for example, in WO 2014/047782 (David, et al.).

The thickness of the pressure sensitive adhesive layer is typically at least 10, 15, 20, or 25 microns (1 mil) ranging up to 500 microns (20 mils) thickness. In some embodiments, the thickness of the pressure sensitive adhesive layer is no greater than 400, 300, 200, or 100 microns. The pressure sensitive adhesive can be coated in single or multiple layers.

In one embodiment, the pressure sensitive adhesive composition has a viscoelastic window as defined by E. P. Chang, J. Adhesion, vol. 34, pp. 189-200 (1991) such that the dynamic mechanical properties of the pressure sensitive adhesive composition as measured by well-known techniques fall within the following ranges measured at 25° C.:

G′ measured at an angular frequency of 0.01 rad/s is greater than 1×10³ Pa
G′ measured at an angular frequency of 100 rad/s is less than 1×10⁶ Pa
G″ measured at an angular frequency of 0.01 rad/s is greater than 1×10³ Pa
G″ measured at an angular frequency of 100 rad/s is less than 1×10⁶ Pa.

In one embodiment, the adhesive composition further meets the Dahlquist criterion for tack in that the G′ measured at 1 rad/s is less than 3×10⁵ Pa.

In some embodiments, the pressure sensitive adhesive composition has a storage modulus G′ of less than 1×10⁶ Pa.

In one embodiment, the pressure sensitive adhesives of the present disclosure have the ability to adhere to a variety of surfaces under extreme conditions. The articles of the present disclosure can be subjected to harsh weather conditions such as temperature extremes, humidity, atmospheric pollutants, road salt, and infrared, visible, and ultraviolet light.

In one embodiment, the pressure sensitive adhesive composition of the present disclosure have a 180° peel to stainless steel of at least 25, 30, 35, 40, 45, 50, 55, 60, 80, 100, 125, or even 150 N/dm at a peel rate of 300 mm/minute peel rate after a 24 hour dwell time at ambient conditions.

In one embodiment, the pressure sensitive adhesive composition of the present disclosure have a 180° peel to polyethylene of at least 10, 15, 20, 25, 30, 35, 40, 45, 50, 55, 60, 80, 100, 125, or even 150 N/dm at a peel rate of 300 mm/minute peel rate after a 24 hour dwell time at ambient conditions.

In one embodiment, the pressure sensitive adhesive composition of the present disclosure have a 180° peel on a fluorinated surface of at least 5, 10, 15, 20, 25, 30, 35, 40, 45, 50, 55, 60, 80, 100, 125, or even 150 N/dm at a peel rate of 300 mm/minute peel rate after a 24 hour dwell time at ambient conditions. Such fluorinated surfaces include: FEP (fluorinated ethylene-propylene) copolymers containing TFE and 5-25 wt % HFP, such as for example “3M DYNEON FLUOROPLASTIC FEP 6307Z” available from 3M Co., St. Paul, Minn.; or PTFE (polytetrafluoroethylene).

In some embodiments, the pressure sensitive adhesive may exhibit the same or higher level of adhesion to stainless steel or a fluorinated surface after exposure to elevated temperatures and humidity, such as after a 72 hour dwell time at 65° C. and 80% relative humidity. In some embodiments, the increase in adhesion is no greater than 300%, 250%, 200%, 150%, 100%, 90%, 80%, or 70% (as determine by subtracting the 24 hr room temperature value from the aged peel value, dividing by the 24 hr room temperature value and multiplying by 100%).

The pressure sensitive adhesives of the present disclosure surprisingly show good adhesion to a variety of low surface energy substrates and under a variety of complex bonding situations.

In addition, the pressure sensitive adhesive may be applied to surfaces with different topographies such as smooth and/or rough surfaces, which make bonding much more complex.

In some applications, organic fluids, such as oil or fuel may contact the substrate and/or the pressure sensitive adhesive and decrease the performance of the pressure sensitive adhesive. In one embodiment, the pressure sensitive adhesive of the present provides resistance to solvent, oil, and benzene/diesel.

In one embodiment, the pressure sensitive adhesive composition of the present disclosure have a swell ratio of less than 1.2 or even a swell ratio of no more than 1.01 in oleic acid, and/or a 70% isopropyl alcohol aqueous solution.

The pressure sensitive adhesive composition described herein may also be disposed on a transparent film for use as a removable or permanent surface protection film. In some embodiments, the pressure sensitive adhesive and transparent film having a transmission of visible light of at least 90 percent.

The pressure sensitive adhesive described herein are suitable for use in the areas of electronics, appliances, automotive, and general industrial products. In some embodiments, the pressure sensitive adhesive can be utilized in (e.g. illuminated) displays that can be incorporated into household appliances, automobiles, computers (e.g. tablets), and various hand-held devices (e.g. phones).

The presently disclosed adhesive composition can be laminated to solid substrates at ambient temperature (25° C.) and provide good high temperature/humidity stability and chemical resistance. The good oil (e.g. oleic acid) and alcohol resistance of the presently disclosed adhesive composition makes the adhesive attractive for various applications including automotive, aerospace, electronics and appliance markets where maintaining adhesive bond strength under high temperature/humidity and chemical environment are of importance.

In some embodiments, the pressure sensitive adhesive described herein are suitable for bonding internal components or external components of an illuminated display devices such as liquid crystal displays (“LCDs”) and light emitting diode (“LEDs”) displays such as cell phones (including Smart phones), wearable (e.g. wrist) devices, car navigation systems, global positioning systems, depth finders, computer monitors, notebook and tablet computer displays.

### Examples

Unless otherwise noted, all parts, percentages, ratios, etc. in the examples and the rest of the specification are by weight (based on solids), and all reagents used in the examples were obtained, or are available, from general chemical suppliers such as, for example, Sigma-Aldrich Company, Saint Louis, Mo.

These abbreviations are used in the following examples: cm=centimeter; dl=deciliter; g=grams; min=minutes; mJ=milliJoules; hr=hour; ° C.=degrees Celsius; and pph=parts per hundred.

### Test Methods

### Molecular Weight Distribution

The molecular weight distribution of the low molecular weight fluorinated polymer was characterized using conventional gel permeation chromatography (GPC). The GPC instrumentation, which was obtained from Waters Corporation (Milford, Mass., USA), included a high pressure liquid chromatography pump (Model 600), an auto-sampler (Model WISP717), and a refractive index detector (Model 2414).

The chromatograph was equipped with three 10 micron PLgel MIXED-B columns 300 mm×7.5 mm, available from Agilent Technologies. (Santa Clara, Calif., USA).

Each sample of polymeric solution was treated with an ethereal diazomethane solution. The reaction was done at room temperature for at least 30 minutes. The sample was dried under a gentle flow of nitrogen until dryness. The residue was dissolved in tetrahydrofuran at a concentration of 0.1 percent (weight/volume). The solution was filtered through a 0.45 micron polytetrafluoroethylene filter, available from Machery- Nagel (Duren-Germany).

The resulting sample was injected into the GPC instrument and eluted with tetrahydrofuran at a rate of 1 milliliter per minute through the columns that were maintained at 40° C. The system was calibrated with polystyrene standards using 3rd order fit analysis to establish a calibration curve.

The number average molecular weight (Mn), the weight average molecular weight (Mw) were determined for each sample against the standard calibration curve.

### Glass Transition Temperature

The glass transition temperature (Tg) was determined following ASTM D 7426-08 (Reapproved 2013), unless otherwise noted, by differential scanning calorimetry (DSC Q200 available from TA Instruments, New Castle, Del.) with liquid nitrogen as the coolant. The samples were equilibrated at about −80° C. and held for 10 min. A DSC scan was obtained from −80° C. to 200° C. (or −80° C. to 150° C.) and a scan rate of 10° C./min was used. The purge gas was helium (99.999% pure, dried over a moisture filter) flowing at 50 mL/min. The midpoint temperature was used to report the Tg.

### Dynamic Mechanical Testing

Dynamic mechanical testing was conducted using standard methods using parallel plate geometry in an oscillatory shear mode with stress and strain oscillating sinusoidally at a controlled frequency, expressed herein as an angular frequency, radians/sec, where one cycle of oscillation is 2π radians. As described in standard viscoelasticity references (e.g. “Viscoelastic Properties of Polymers,” J. D. Ferry, 3^{rd} edition, John Wiley and Sons, 1980), the material property parameters, dynamic modulus (G*), and phase angle (δ) were determined. G* is the ratio of peak-to-peak stress amplitude to peak-to-peak strain amplitude and the phase angle is the shift between the phase of the stress wave and that of the strain wave, expressed either in degrees or radians. One full cycle of oscillation is 360 degrees or 2π radians. From these parameters, the parameters G′, G″ and tans are derived as follows:

G′=G* cosδ

G″=G*sinδ

tanδ=tangent of δ which is also equal to G″/G′

A sample of the adhesive composition was prepared by compression molding or by lamination of coated layers to a thickness of approximately 1 mm. From this sample, an 8 mm diameter disk was cut using a die. That disk shaped sample was mounted between two 8 mm diameter parallel plate fixtures of a TA Instruments Discovery Hybrid Rheometer Model DHR-3 or an ARES G2 rheometer also made by TA Instruments.

### Temperature Ramp Test to Determine Dma Tg

These tests were conducted using the DHR-3 rheometer. Using automatic control of the axial force of the fixtures on the sample, the material was subjected to cyclic shear oscillation while the instrument monitored the oscillating shear stress and shear strain. A constant oscillation angular frequency of 1 rad/s (cyclic frequency of 1/2π Hz) was applied with a shear strain of 5% while the sample temperature was ramped from 25° C. to −65° C. at a rate of 3° C./min. When the shear stress exceeded 50 kPa, the system switched to a controlled shear stress mode at a constant shear stress of 50 kPa. When the G* exceeded 5×10⁸ Pa or when the temperature reached −65° C. (whichever came first), the temperature was returned to 20° C. while maintaining axial force control. The temperature was then ramped from 20° C. to 150° C. or until the G* value fell below 10³ Pa using a constant strain of 5%.

The DMA glass transition temperature (DMA Tg) was taken as the temperature at which the value of the tangent of the phase angle, δ, (tanδ) reached a maximum during the phase where the shear storage modulus rises from about 10⁵ Pa to above 10⁸ Pa as the temperature drops.

### Frequency Sweep Test for Viscoelastic Window and Dahlquist Criterion Properties

These tests were conducted using the ARES G2 rheometer. The 8 mm disk shaped sample was mounted between 8 mm diameter fixtures, first applying an axial force of about 100 g to achieve good bonding between the fixture and the sample and then the axial force was controlled near zero g +/−20 g. A frequency sweep was conducted with the sample controlled at 25° C. and a constant shear strain of 5% to measure the properties at 0.01, 1, and 100 rad/s angular frequency.

### Adhesive Testing

Unless otherwise indicated, prior to testing all adhesive samples were conditioned in a climate room set at ambient conditions (23° C. +/−2° C. and 50% +/−5% relative humidity) during 12 hours.

### Substrates Used

Stainless steel panels: The stainless steel panels (51 mm wide by 127 mm long by 1.2 mm thick having a bright annealed finish (in accordance with Specification ASTM A666, Type 304) were obtained from ChemInstruments, Incorporated, Fairfield, Ohio). Prior to use stainless steel panels were cleaned by wiping the panels with a lint free tissue first with a pass of methyl ethyl ketone (MEK), followed by a wipe with n-heptane and finally another pass with methyl ethyl ketone (MEK). Wiping of the panels per pass of solvent was always done until dryness.

Tetrafluoroethene-hexafluoropropene: An FEP (a co-polymer derived from tetrafluoroethene and hexafluoropropene) film was made from FEP granules being available under the trade designation “FEP 6307” from 3M Co. The FEP films were attached to clean stainless steel plates with an adhesive film. Prior to use, the exposed FEP surface of the multilayered construction was cleaned with a 90/10 mixture of isopropyl alcohol (IPA) and water.

Polyethylene: The polyethylene (PE) test panels were PE covered aluminum panels. PE film having a thickness of 330 μm was prepared from polyethylene pellets, available under trade designation “VORIDIAN POLYETHYLENE 1550P, STA 211” from Eastman Chemical Co. (Kingsport, Tenn., USA). Test panels were prepared by fixing the PE film to the aluminum plate with adhesive tape. The rougher surface of the PE was affixed to the aluminum plate with the smoother surface outwardly facing for testing. The PE covered aluminum panels were not cleaned prior to use.

### 180° Peel Adhesion

All 180° peel adhesion tests were performed in accordance with AFERA 5001 (version 2004) test method.

Adhesive test samples were prepared by slitting adhesive strips of 25.4 mm×300 mm in dimension using a specimen cutter holding two single-edged razor blades in parallel planes of the adhesive. The strip was placed without pressure onto a (cleaned) test substrate, after which the strip was fixed onto the substrate using a 2 kg hand-held rubber-covered roller at a rate of 10 +/−0.5 mm/s with 2 passes in each direction. After a dwell time, as indicated in the examples, in the climate room, a 180° peel test was performed using a FP-2255 Peel Tester (manufactured by Thwing-Albert Instrument Company), with data collected and averaged over 10 seconds. The adhesive strip was pulled at a speed of 300 mm/min. Three measurements were made per example and the average recorded in N/dm.

Static Shear Strength on Stainless Steel (SS)

The static shear test method determines the ability of pressure-sensitive adhesive tapes to remain adhered under constant load applied parallel to the surface of the tape and substrate. The test was performed according to AFERA 5012 Test Method “Self Adhesive Tapes-Measurement of Static Shear Adhesion EN 1943 2002” (version 2004).

Static shear strength was measured on cleaned stainless steel panels having a dimension of 50 mm by 125 mm (and a minimum thickness of 1.1 mm).

A 1 inch (25.4 mm) wide strip of adhesive was cut from the adhesive tape by using a specimen cutter holding two single-edge razor blades in parallel planes, the blades spaced 1 inch (25.4 mm) apart. The adhesive strip was then placed onto a clean stainless steel panel covering a 1 inch×1 inch (25.4 mm×25.4 mm) area of the stainless steel panel. The adhesive strip was then rolled-over twice in each direction using a hand-held rubber-covered 2 kg hand-roller at an approximate rate of 10 mm +/−0.4 mm/s. A 1000 g (1 kg) weight was used as the static load. The test samples were placed on an automated timing apparatus in an air conditioned room at ambient conditions (23° C. +/−2° C. and 50% +/−5% relative humidity). Alternatively, the samples were left in the air conditioned room for a time as indicated in the example (indicated as ‘dwell time’) before testing. The time when the load dropped was recorded (min). When the load did not fall down after 10000 min, the test was discontinued and the result identified as 10000+. The data reported are the averages of three measurements.

### Chemical Resistance Test

Samples were prepared by slitting test strips 0.5 inch×0.5 inch (12.7 mm×12.7 mm) from each of the adhesive transfer tape samples. Then, the release liner on one surface was removed and the test strips were attached (stuck) to the bottom of a glass petri dish. The release liner on the second, exposed surface of the test strips were removed and the petri dish containing the attached sample test strips were set aside to dwell at room temperature (about 23° C.) for 15 minutes. The test strips were then submerged in either (a) oleic acid, or (b) a mixture of isopropyl alcohol (IPA) and water at a weight ratio of 70:30 (IPA/H₂O) at 70° C. for 8 hrs. The resistance of the adhesive sample to oleic acid, or to IPA/H20 mixture was rated using the following guidelines and reported.

Observation Chemical Resistance Rating: 1=Adhesive sample came off the petri dish or dissolved completely 3=Adhesive sample partially detached or dissolved along the edge 5=Adhesive sample did not detach or dissolve

Materials Table

| Designation | Descriptor | Supplier |
|---|---|---|
| AA | Acrylic acid | Arkema, Colombes, France |
| ABP | Acryloyl benzophenone | Prepared generally according |
| | | to U.S. Pat. No. 4,737,559, |
| | | example A |
| AEBP | para-acryloxyethoxybenzophenone | Prepared generally according |
| | | to U.S. Pat. No. 4,737,559, |
| | | example B |
| IBOMA | Isobornyl methacrylate | Sigma Aldrich |
| IBOA | Isobornyl acrylate | Sigma Aldrich |
| IEM | Isocyanato ethyl methacrylate (KARENZ MOI) | Showa Denko, Tokyo, Japan |
| C4MA | N-methyl | Can be prepared similar to |
| | perfluorobutylsulphonamidoethylmethacrylate | example 2 in U.S. Pat. |
| | | No. 6,664,354 |
| C4A | N-methyl | Prepared generally according to |
| | perfluorobutylsulphonamidoethylacrylate | example 2 in U.S. Pat. |
| | | No. 6,664,354 |
| MEFBSEIEM | 1/1 adduct of C4MA and IEM | Prepared generally according to |
| | | the method listed below |
| MMA | Methyl methacrylate | Brentag A G, Mulheim, Germany |
| F5STYR | Pentafluorostyrene | Sigma Aldrich |
| FC1 | Low viscosity fluoropolymer made from | Can be prepared similar to |
| | VDF/HFP/TFE copolymer having a theoretical | Example 4 of US Pat. |
| | monomer ratio of 32.6 wt % VDF/43.3 wt % HFP/24.1 | No. 6,693,152 |
| | wt % TFE; Tg −12° C. | |
| CF3EMA | 2,2,2-trifluoroethyl methacrylate | ABCR, Karlsruhe, Germany |
| FBMA | 4,4,4,3,3,2,2-heptafluorobutylmethacrylate | Sigma-Aldrich |
| DMAEMA | Dimethylaminoethyl methacrylate | Degussa A G, Essen, Germany |
| IOA | Isooctyl acrylate | Sigma Aldrich |
| NVC | N-Vinyl caprolactam | Sigma Aldrich |
| PETMP | Pentaerythritol tetrakis(3-mercaptopropionate) | Sigma Aldrich |
| VAZO-88 | 1,1′-Azobis(cyclohexanecarbonitrile) | Sigma Aldrich |
| V-601 | Dimethyl 2,2′-azobis(2-methylpropionate) | Wako Pure Chemical Industries, |
| | | Ltd., Osaka, Japan |
| MEHQ | Hydroquinone monomethylether | Sigma Aldrich |
| BA | Butylacrylate | Sigma Aldrich |
| PPVE2 | CF₂═CFOCF₂CF(CF₃)OCF₂CF₂CF₃, Perfluoro(5- | Available from Aber GmbH, |
| | methyl-3,6-dioxanon-1-ene) | Kalsruhe, Germany |

Synthesis of MEFBSEIEM

MEFBSEIEM was prepared as followed: A 500 ml 3 neck flask was charged with 100 g C4MA, 0.05 g Phenothiazine and 0.02 g MEHQ, and 175 g ethylacetate (EtAc), the mixture was stirred and warmed up until 65° C., 15% of the ethylacetate was distilled off under mild vacuum with a Dean-Stark apparatus. Then the reaction was put under nitrogen and lined out at 50° C. and 0.2 g Dibutyltin laurate (Merck) was added. 43.4 g isocyanato ethyl methacrylate (IEM, Karenz MOI) was slowly added in a matter that the temperature did not exceed 65° C. The reaction was followed with IR and stopped until the peak at 2272 cm⁻¹ disappeared. After reaction, the solvent was removed under vacuum which gave a white solid after cooling. The structure was confirmed with NMR (nuclear magnetic reasonance).

### Synthesis of Low Molecular Weight Fluorinated Polymers

The composition of the low molecular weight fluorinated polymers used as tackifier in the examples and comparative examples is provided in Table 1 (TACK 1 to TACK 9).

### Synthesis of POLY-FSSTYR (TACK 8)

A 100 ml 3 neck flask was charged with 25 g pentafluorostyrene (FSSTYR), 25 g butylacetate (Sigma Aldrich) and 3 g PETMP. The mixture was stirred under nitrogen flow during 30 min. Then the mixture was warmed up to 100° C. At a temperature of 50° C., 0.05 g VAZO-88 was added. The reaction was stirred during 24 h. After 2 hr and 16 hr additional aliquots of 0.05 g VAZO-88 were added.

### Synthesis of Low Molecular Weight Fluorinated (Meth)Acrylate Polymers (TACK 1 to TACK 7)

The composition of the low molecular weight fluorinated (meth)acrylate polymers used as tackifier in the examples and comparative examples is provided in Table 1 (TACK1 to TACK 7).

The low molecular weight fluorinated (meth)acrylate polymers were prepared according to the general method as outlined below:

Glass bottles were charged with the monomers, n-butylacetate and chain transfer agent (CTA) in amounts (% by weight) as given in Table 1. The amount of solvent was calculated to have a solids content between 40 and 60% by weight. The bottles were sealed and rolled during 2 hr to homogenize the mixture. Then 0.3% by weight of thermal initiator VAZO-88 (used as a 1% solution in n-butylacetate) was added. The bottles were degassed with a nitrogen flow of 1.0 liter/min during 3 minutes and then sealed. The reaction was run during 20 hours in a Launder-O-Meter set at 80° C. The composition of the low molecular weight fluorinated (meth)acrylate polymers was analyzed with GPC (Mn and Mw) and with DSC (Tg) according to the methods outlined above.

TABLE 1
Composition of low molecular weight fluorinated polymers
(TACK 1 to TACK 9)

| Low | | | | | | | |
|---|---|---|---|---|---|---|---|
| molecular | | | | | | | |
| weight | | | | | | | |
| fluorinated | | % by | CTA (PPH | TG | Mn | | % |
| polymer | Monomers | weight | Monomer) | (° C.) | (kg/mol) | Mw | solids |
| TACK 1 | C4MA/IBOMA/NVC | 75/24/1 | PETMP | −6.0 | 2.3 | 2.6 | 50 |
| | | | (30) | | | | |
| TACK 2 | C4MA/NVC/AEBP | 98/1/1 | PETMP | −8.0 | 2.1 | 2.7 | 60 |
| | | | (29) | | | | |
| TACK 3 | C4MA/IBOA/NVC | 75/24/1 | PETMP | −10.0 | 2.3 | 2.7 | 50 |
| | | | (30) | | | | |
| TACK 4 | CF₃EMA | 100 | PETMP | −13.7 | 2.3 | 3.3 | 60 |
| | | | (25) | | | | |
| TACK 5 | FBMA/NVC/AEBP | 97/1.5/1.5 | PETMP | −16.0 | 3.2 | 4.0 | 60 |
| | | | (15.5) | | | | |
| TACK 6 | MEFBSEIEM/NVC | 99/1 | PETMP | 10.5 | 2.0 | 3.9 | 60 |
| | | | (20) | | | | |
| TACK 7 | MEFBSEIEM/MMA | 95/5 | PETMP | 15.6 | 3.5 | 5.0 | 60 |
| | | | (16) | | | | |
| TACK 8 | POLY-F5STYR | 100 | PETMP | 28.3 | 3.5 | 4.3 | 50 |
| | | | (12) | | | | |
| TACK 9 | FC1 | 100 | none | −11.8 | ND | ND | 100 |

ND: not determined

### Synthesis of High Molecular Weight Acrylate Polymer (ACRYL)

High molecular weight acrylate polymer ACRYL 1 (IOA/AA/ABP 99.5/0.5/0.05) was produced via solution polymerization, in a solvent mixture of ethylacetate/heptane (in a weight ratio of 95/5) at 45% solids. Therefore IOA, AA and ABP were dissolved in the solvent mixture and allowed to polymerize. The polymerization was initiated by an azo initiator (V-601; 0.2% by weight, based on the monomers) and the mixture was polymerized under constant stirring for 20 hours at 60° C. The acrylate polymer was characterized by having an inherent viscosity (IV) of 0.89 as measured according to ASTM D 2857-95 (measured on a 0.3g/dl solution of the acrylate polymer in ethylacetate/heptane (95/5), at 25° C., using a Canon Fenske viscosimeter). The acrylate polymer solution was used as such in the examples.

High molecular weight acrylate polymers ACRYL 2 to ACRYL 10 were prepared essentially according to the same procedure as outlined for ACRYL 1. The composition of all high molecular weight acrylate polymers is listed in table 2.

TABLE 2
Composition of (meth)acrylate polymers ACRYL 1 to ACRYL 10

| | | | Solvent ratio | IV (0.3 |
|---|---|---|---|---|
| | | Monomer ratio | EtAc/acetone/heptane | g/dl in |
| ACRYL | Monomer composition | (% by weight) | (% by weight) | EtAc |
| ACRYL 1 | IOA/AA/ABP | 99.5/0.5/0.05 | 95.1/0/4.9 | 0.89 |
| ACRYL 2 | IOA/AA/ABP ⁽¹⁾ | 99.5/0.5/0.05 | 100/0/0 | 0.61 |
| ACRYL 3 | IOA/AA/ABP | 97.0/3.0/0.05 | 90.2/0/9.8 | 0.90 |
| ACRYL 4 | IOA/NVC/ABP | 99.5/0.5/0.05 | 90.2/0/9.8 | 0.86 |
| ACRYL 5 | IOA/NVC/ABP | 97.0/3.0/0.05 | 90.2/0/9.8 | 0.91 |
| ACRYL 6 | IOA/AA | 94.0/6.0 | 0/35/65 | 0.80 |
| ACRYL 7 | BA/AA/ABP | 97.0/3.0/0.2 | 50/50 | 0.85 |
| ACRYL 8 | BA/FBMA/AA/ABP | 94.0/5.0/1.0/0.05 | 50/50 | 0.76 |
| ACRYL 9 | BA/C4A/AA/ABP | 94.0/5.0/1.0/0.05 | 50/50 | 0.81 |
| ACRYL 10 | BA/PMVE2/AA/ABP | 89.2/10.0/0.5/0.05 | 50/50 | 0.74 |

Note:
⁽¹⁾ comprising 0.08% by weight PETMP (based on total weight of monomers)

### Synthesis of Crosslinking Polymer (XL-POL)

A UV crosslinking polymer (“XL-POL”) IOA/DMAEMA/AEBP 90/5/5 was produced via solution polymerization in solvent mixture of acetone/ethylacetate (in a weight ratio of 70/30) at 45% solids. The polymerization was started by an azo initiator (V-601; 0.2% by weight, based on the monomers) and the polymerization took place under constant stirring for 20 hours at 60° C. The UV crosslinking polymer was characterized by having in inherent viscosity (IV) of 0.67 as measured according to ASTM D 2857 (measured on a 0.3 g/dl solution of the acrylate polymer in ethylacetate at 25° C., using a Canon Fenske viscosimeter). The so formed crosslinking polymer solution was used as such.

### Procedure for Making Adhesive Layers

Adhesive compositions were prepared by blending the acrylate polymers with low molecular weight fluorinated polymers and optional crosslinking polymers in amounts as listed in the examples (in parts solids). Adhesive layers were made by knife coating the solvent based adhesive mixtures onto white, double-sided siliconized paper liner (available from Mondi Akrosil, USA) having a thickness of 75 μm. The coatings were dried at room temperature during 6 minutes, followed by drying at 105° C. during 7 minutes and at 120° C. during 1 min. The thickness of the dried adhesive layer varied is recorded in the tables. The dried coatings were irradiated with 65 or 75 mJ/cm²UV-C (as indicated in the tables); measured with a Power Puck from EIT Inc., Sterling, VA), using a medium pressure mercury lamp (available from TCS Technologies, Cookeville, Tenn.).

After curing, the adhesives were laminated on a 50 μm thick nanoetched PET liner. The liner side was always used for measuring adhesive properties. Adhesive layers were prepared by solution processing. Therefore, solvent based mixtures of high molecular weight acrylate polymers and low molecular weight fluorinated polymers were prepared as indicated in the examples.

### Examples

Adhesive formulations (ADH 1 to ADH 25) and reference adhesive REF-ADH.

Solvent based PSA formulations were prepared by blending high molecular weight acrylate polymers (ACRYL 1 to ACRYL 10) with low molecular weight fluorinated polymers (TACK 1 to TACK 9) and optional UV crosslinking polymer (XL POL) in amounts (parts based on solids) as listed in table 3. Reference adhesive REF-ADH was prepared in the same way, but without the addition of low molecular weight fluorinated polymer.

TABLE 3
Composition (parts solids) of adhesive formulations
ADH 1 to ADH 25 and reference adhesive REF-ADH

| | | Low molecular weight | | |
|---|---|---|---|---|
| | | fluorinated polymer | | XL POL |
| | | | Parts per 100 | Parts per 100 |
| | High molecular | | partshigh | parts high |
| | weight acrylate | | molecular | molecular |
| | polymer 100 | | weight acrylate | weight acrylate |
| Adhesive | parts | Type | polymer | polymer |
| ADH 1 | ACRYL 1 | TACK 1 | 25 | / |
| ADH 2 | ACRYL 1 | TACK 1 | 25 | 1 |
| ADH 3 | ACRYL 1 | TACK 1 | 50 | 1 |
| ADH 4 | ACRYL 1 | TACK 3 | 25 | 1 |
| ADH 5 | ACRYL 1 | TACK 3 | 50 | 1 |
| ADH 6 | ACRYL 1 | TACK 3 | 25 | 2 |
| ADH 7 | ACRYL 1 | TACK 3 | 50 | 2 |
| ADH 8 | ACRYL 2 | TACK 3 | 25 | 1 |
| ADH 9 | ACRYL 3 | TACK 1 | 25 | 1 |
| ADH 10 | ACRYL 6 | TACK 1 | 25 | 1 |
| ADH 11 | ACRYL 4 | TACK 1 | 25 | 1 |
| ADH 12 | ACRYL 5 | TACK 1 | 25 | 1 |
| ADH 13 | ACRYL 1 | TACK 1 | 50 | 2 |
| ADH 14 | ACRYL 7 | TACK 1 | 50 | 2 |
| ADH 15 | ACRYL 7 | TACK 5 | 25 | 2 |
| ADH 16 | ACRYL 7 | TACK 4 | 25 | 2 |
| ADH 17 | ACRYL 1 | TACK 6 | 25 | 1 |
| ADH 18 | ACRYL 1 | TACK 7 | 25 | 1 |
| ADH 19 | ACRYL 1 | TACK 8 | 25 | 1 |
| ADH 20 | ACRYL 1 | TACK 9 | 25 | 1 |
| ADH 21 | ACRYL 4 | TACK 9 | 25 | 1 |
| ADH 22 | ACRYL 8 | TACK 5 | 50 | 2 |
| ADH 23 | ACRYL 9 | TACK 2 | 50 | 2 |
| ADH 24 | ACRYL 9 | TACK 9 | 50 | 2 |
| ADH 25 | ACRYL 10 | TACK 9 | 50 | 2 |
| REF-ADH | ACRYL 1 | none | none | 1 |

### Examples EX 1 to EX 18 and Reference Example REF-1

In examples EX 1 to EX 18 the adhesive performance of adhesives comprising a high molecular weight acrylate polymer and a low molecular weight fluorinated polymer derived from a fluorinated (meth) acrylate monomer according to formula III was evaluated. The high molecular weight acrylate polymers comprised units derived from a C4- or C8-alkyl acrylate monomer and various levels of polar comonomers. In reference example REF-1, performance was evaluated of an adhesive having the same acrylate adhesive as used in example 2, but without addition of a low molecular weight fluorinated polymer. Except the adhesive composition of example 1, all other adhesives and the Ref adhesive contained a crosslinking polymer. Adhesive layers were prepared from the solvent based adhesive formulations ADH 1 to ADH 18 and REF-ADH respectively, according to the general procedure (Procedure for making adhesive layers) outlined above.

Test specimen were prepared for the static shear on stainless steel and 180° peel adhesion on various substrates as previously described. Shown in Table 4 below is the adhesive used, the adhesives coating thickness, the UV-C irradiation energy and the test results for peel adhesion and static shear strength.

Rheology test was performed for EX 13 and EX 14 according to the method as outlined above. The rheology data are listed in Table 4a. Adhesive formulations ADH 2, ADH 6, ADH 13, and ADH 14 were subjected to the chemical resistance test as outlined above. The observation rating was 5 for all adhesives. No difference was observed between the test in

IPA/H₂O or ethanol/water.

TABLE 4
Adhesive performance examples EX 1 to EX 18
and Reference example REF-1

| | | | | 80°peel (1 day dwell) | | | RT shear SS; 20 min |
|---|---|---|---|---|---|---|---|
| | | | | (N/dm) | | | dwell, |
| | | Thickness | UV-C | | PE (STA | | 1 kg/1 inch × |
| Example | Adhesive | (μm) | (mJ/cm²) | FEP 6307 | smooth) | SS | 1 inch (min) |
| EX 1 | ADH 1 | 45 | 65 | 13.0 | 28.4 | NA | 269 |
| EX 2 | ADH 2 | 55 | 65 | 22.6 | 24.3 | NA | 10000+ |
| EX 3 | ADH 3 | 55 | 65 | 11.7 | 33.6 | NA | 5603 |
| EX 4 | ADH 4 | 55 | 75 | 10.6 | 31.9 | NA | 2190 |
| EX 5 | ADH 5 | 55 | 75 | 6.7 | 31.5 | NA | 321 |
| EX 6 | ADH 6 | 50 | 75 | 22.1 | 26.0 | NA | 1477 |
| EX 7 | ADH 7 | 50 | 75 | 17.7 | 28.4 | NA | 656 |
| EX 8 | ADH 8 | 55 | 70 | 20.1 | 42.2 | NA | 133 |
| EX 9 | ADH 9 | 60 | 70 | NA | 15.4 | 54.4 | 10000+ |
| EX 10 | ADH 10 | 60 | 70 | NA | 9.5 | 67.4 | 2121 |
| EX 11 | ADH 11 | 61 | 70 | 39.0 | 26.4 | 41.4 | 524 |
| EX 12 | ADH 12 | 61 | 70 | 23.2 | 23.6 | 46.5 | 1683 |
| EX 13 | ADH 13 | 65 | 70 | 37.8 | 26.8 | 47.7 | 2400 |
| EX 14 | ADH 14 | 60 | 70 | NA | 10.6 | 70.5 | 10000+ |
| EX 15 | ADH 15 | 62 | 70 | 15.0 | 3.2 | 33.1 | 10000+ |
| EX 16 | ADH 16 | 62 | 70 | NA | 11.4 | 72.1 | 10000+ |
| EX 17 | ADH 17 | 67 | 70 | 5.9 | 5.1 | 93.4 | 10000+ |
| EX 18 | ADH 18 | 67 | 70 | 6.3 | 3.2 | 36.6 | 8428 |
| REF-1 | REF-ADH | 55 | 65 | 12.1 | 9.3 | 25.9 | 10000+ |

Note:
NA: not available

TABLE 4a
Rheology data for EX 13 and EX 14

| | G′ at 0.01 | G′ at 100 | G″ at 0.01 | G″ at 100 | G′ at 1 |
|---|---|---|---|---|---|
| Example | rad/s | rad/s | rad/s | rad/s | rad/s |
| EX 13 | 3.77 × 10³ | 7.34 × 10⁴ | 1.30 × 10³ | 4.48 × 10⁴ | 1.49 × 10⁴ |
| EX 14 | 7.80 × 10³ | 1.34 × 10⁵ | 4.98 × 10³ | 8.25 × 10⁴ | 4.25 × 10⁴ |

### Examples EX 19 to EX 21

In examples EX 19 to EX 21 adhesive performance of formulations comprising a high molecular weight acrylate polymer and a low molecular weight fluorinated polymer derived from a styrene monomer or a vinyl monomer were evaluated. The high molecular weight acrylate polymers comprised units derived from a C8-alkyl acrylate monomer and different polar comonomers. Adhesive layers were prepared from the solvent based adhesive formulations ADH 19 to ADH 21 respectively, according to the general procedure (Procedure for making adhesive layers) outlined above. Test specimen were prepared for the static shear on stainless steel and 180° peel adhesion on various substrates as previously described. In addition the adhesive properties of example 24 were measured again after heat aging during 1 week at 70° C. (reported as EX 24 H). Shown in Table 5 below is the adhesive used, the adhesives coating thickness, the UV-C irradiation energy and the test results for peel adhesion and static shear strength. Adhesive formulation ADH 19 was subjected to the chemical resistance test as outlined above. The observation rating was 5 for both the test in IPA/H₂O or in ethanol/water.

TABLE 5
Adhesive performance examples EX 19 to EX 21

| | | | | 180°peel (1 day dwell) | | | RT shear SS; |
|---|---|---|---|---|---|---|---|
| | | | | (N/dm) | | | 20′ dwell, 1 kg/1 |
| | | Thickness | UV-C | | PE (STA | | inch × 1 inch |
| Example | Adhesive | (μm) | (mJ/cm²) | FEP 6307 | smooth) | SS | (min) |
| EX 19 | ADH 19 | 60 | 70 | 12.6 | 12.6 | 36.6 | 10000+ |
| EX 20 | ADH 20 | 62 | 70 | 32.3 | 23.6 | 35.9 | 10000+ |
| EX 20 H | | | | 28.8 | 18.9 | 36.2 | 10000+ |

Note:
Ex 20 H: adhesive performance measurement after heat aging during 1 week at 70° C.

### Examples EX 22 to EX 25

In examples EX 22 to EX 25 adhesive performance of formulations comprising a high molecular weight, partially fluorinated acrylate polymer and different low molecular weight fluorinated polymers were evaluated. Adhesive layers were prepared from the solvent based adhesive formulations ADH 22 to ADH 25 respectively, according to the general procedure (Procedure for making adhesive layers) outlined above. Test specimen were prepared for the static shear on stainless steel and 180° peel adhesion on various substrates as previously described. Shown in Table 6 below is the adhesive used, the adhesives coating thickness, the UV-C irradiation energy and the test results for peel adhesion and static shear strength. Dynamic mechanical analysis and rheology test was performed on EX 22-EX 24 according to the method as outlined above. The rheology data are listed in table 6a. Adhesive formulations ADH 22, ADH 23 and ADH 24 were subjected to the chemical resistance test as outlined above. The observation rating was 5 for ADH 22 and ADH 23 and 4 for ADH 24. No difference in rating was observed between the test in IPA/H₂O or ethanol/water.

TABLE 6
Adhesive performance examples EX 22 to EX 25

| | |
|---|---|
| 180°peel (1 day dwell) | RT shear SS; |
| (N/dm) | 20′ dwell, 1 kg/1 |

| | | Thickness | UV-C | | PE (STA | | inch × 1 inch |
|---|---|---|---|---|---|---|---|
| Example | Adhesive | (μm) | (mJ/cm²) | FEP 6307 | smooth) | SS | (min) |
| EX 22 | ADH 22 | 63 | 70 | 11.8 | 11.8 | 66.2 | 10000+ |
| EX 23 | ADH 23 | 61 | 70 | 14.2 | 6.3 | 41.8 | 5518 |
| EX 24 | ADH 24 | 59 | 70 | 29.6 | 15.0 | 45.7 | 10000+ |
| EX 25 | ADH 25 | 57 | 70 | 29.2 | 15.4 | 47.3 | 10000+ |

TABLE 6a
Storage and loss modulus (in Pa)

| | G′ at 0.01 | G′ at 100 | G″ at 0.01 | G″ at 100 | G′ at 1 |
|---|---|---|---|---|---|
| Example | rad/s | rad/s | rad/s | rad/s | rad/s |
| EX 22 | 7.88 × 10³ | 1.37 × 10⁵ | 4.55 × 10³ | 6.29 × 10⁴ | 4.44 × 10⁴ |
| EX 23 | 1.01 × 10⁴ | 1.21 × 10⁵ | 6.49 × 10³ | 5.76 × 10⁴ | 4.19 × 10⁴ |
| EX 24 | 1.65 × 10⁴ | 1.47 × 10⁵ | 7.24 × 10³ | 6.76 × 10⁴ | 5.29 × 10⁴ |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will control.

1. A pressure sensitive adhesive comprising:
(a) a high molecular weight (meth)acrylate polymer wherein the high molecular weight (meth)acrylate polymer is derived from
(i) a C4 to C24 (meth)acrylate ester monomer; and
(ii) 0 to less than 10 wt % of a polar co-monomer based on the weight of the (meth)acrylate polymer; and
(b) 10 to 100 parts of a low molecular weight fluorinated polymer per 100 parts of the high molecular weight (meth)acrylate polymer, wherein the low molecular weight fluorinated polymer has a Tg of less than 40° C.

2. The pressure sensitive adhesive according to claim 1, wherein the low molecular weight fluorinated polymer has a number average molecular weight (Mₙ) of less than 10 kg/mol.

3. The pressure sensitive adhesive of claim 1, wherein at least 10% of all of the C—H and C—F bonds in the low molecular weight fluorinated polymer are C—F bonds.

4. The pressure sensitive adhesive of claim 1, wherein the low molecular weight fluorinated polymer is derived from a fluorinated (meth)acrylate monomer, a fluorinated vinyl monomer, a fluorinated vinyl ether monomer, a fluorinated styrene monomer, and combinations thereof.

5. The pressure sensitive adhesive of claim 1, wherein the low molecular weight fluorinated polymer is derived from a fluorinated (meth)acrylate and optionally a hydrocarbon (meth)acrylate.

6. The pressure sensitive adhesive of claim 5, wherein the fluorinated (meth)acrylate monomer is of the formula II: 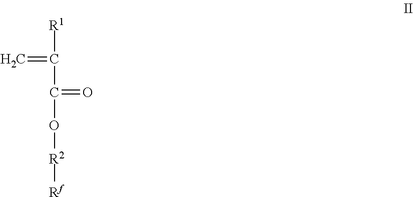
wherein R¹ is H or CH₃; R² is a linking group; R^{f} is a fluorinated alkyl group, optionally comprising a catenated heteroatom.

7. The pressure sensitive adhesive of claim 6, wherein R² of formula II is an alkylene.

8. The pressure sensitive adhesive of claim 6, wherein R² of formula II comprises at least one of sulfonylamide group and a carboxyamide group.

9. The pressure sensitive adhesive of claim 6 any one of claims 6 8, wherein Rf is a C1 to C10 perfluorinated alkyl group.

10. The pressure sensitive adhesive of claim 6, wherein the fluorinated (meth)acrylate monomer is of the formula III: 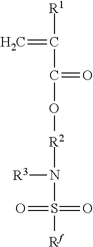
wherein R¹ is H or CH₃; R² is a linking group; R³ is H or an alkyl group; R^{f} comprises a perfluorinated group.

11. The pressure sensitive adhesive claim 4, wherein the fluorinated styrene monomer is of the formula: 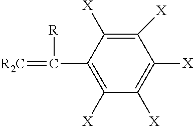
wherein each R is independently selected from H or F and each X is independently selected from H or F, wherein at least one X is F.

12. The pressure sensitive adhesive of claim 1, wherein the low molecular weight fluorinated polymer is derived from vinylidene fluoride, hexafluoropropylene, tetrafluoroethylene, and combinations thereof.

13. The pressure sensitive adhesive of claim 1, wherein the polar co-monomer comprises at least one of meth)acrylic acid, itaconic acid, fumaric acid, crotonic acid, citraconic acid, and maleic acid, β-carboxyethylacrylate; N,N-dialkylaminoalkyl (meth)acrylates, N-vinyl-2-pyrrolidone, N-vinyl caprolactam, and acrylonitrile; N-dialkyl(meth)acrylamide; N-alkyl (meth) acrylamide; acrylamide; acryloylmorpholine; and combinations thereof.

14. The pressure sensitive adhesive of claim 1, wherein the high molecular weight (meth)acrylate polymer is partially fluorinated, comprising at least 10 or even 30 wt % units derived from fluorinated (meth)acrylate monomers.

15. The pressure sensitive adhesive of claim 1, wherein the pressure sensitive adhesive is crosslinked.

16. (canceled)

17. The pressure sensitive adhesive of claim 1, wherein the low molecular weight fluorinated polymer comprises the following interpolymerized structure: 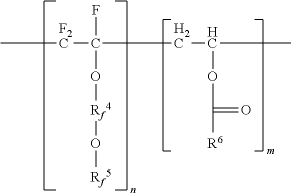
where R_{f}⁴ is a perfluorinated alkylene group comprising from 1 to 6 carbon atoms; R_{f}⁵ a perfluorinated alkyl group comprising from 1 to 10 carbon atoms; R⁶ is is a non-fluorinated alkyl, aryl, or alkylaryl group comprising 1 to 12 carbon atoms; n is an integer of at least 2; and m is an integer of at least 2.

18. The pressure sensitive adhesive of claim 1, wherein the low molecular weight fluorinated polymer comprises the following interpolymerized structure: 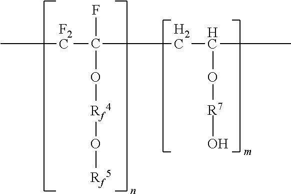
where R_{f}⁴ is a perfluorinated alkylene group comprising 1-6 carbon atoms; R_{f}⁵ is a perfluorinated alkyl group comprising 1-10 carbon atoms; R⁷ is an alkylene, an arylene or an alkylarylene group that may be substituted and comprising from 1 to 18 carbon atoms; n is an integer of at least 2; and m is an integer of at least 2.

19. The pressure sensitive adhesive of claim 1, wherein the pressure sensitive adhesive meets all of the following criteria:
G′ measured at an angular frequency of 0.01 rad/s is greater than 1×10³ Pa
G′ measured at an angular frequency of 100 rad/s is less than 1 ×10⁶ Pa
G″ measured at an angular frequency of 0.01 rad/s is greater than 1×10³ Pa
G″ measured at an angular frequency of 100 rad/s is less than 1×10⁶ Pa.

20. The pressure sensitive adhesive of claim 1, having a value of G′ measured at 25° C. and an angular frequency of 1 rad/s of less than 3×10⁵ Pa.

21-23 (canceled)

24. A multilayered article comprising the pressure sensitive adhesive according to claim 1 and a backing.

25. A multilayered article comprising the pressure sensitive adhesive according to claim 1 and a liner.
